(19) United States
(12) Patent Application Publication
(10) Pub. No.: US 2017/0337766 A1
(43) Pub. Date: Nov. 23, 2017

(54) GAMING MACHINE WITH REAR PROJECTION FEATURE

(71) Applicants: Milo Borissov, Dubai Sports City (AE); Rossi McKee, Indianapolis, IN (US)

(72) Inventors: Milo Borissov, Dubai Sports City (AE); Rossi McKee, Indianapolis, IN (US)

(21) Appl. No.: 15/596,272

(22) Filed: May 16, 2017

Related U.S. Application Data
(60) Provisional application No. 62/337,682, filed on May 17, 2016.

(51) Int. Cl. G07F 17/32

(52) U.S. Cl. CPC G07F 17/3211; G07F 17/3202; G07F 17/3267

(57) ABSTRACT

A gaming machine has a front and a rear. One or more player interface devices such as a primary game display, buttons and the like, are located at the front for engaging by a player of the gaming machine. In addition, the gaming machine has a secondary display device. The secondary display device may comprise a projector which is located at a rear of the gaming machine and which is configured to project information on the back of the gaming machine, whereby the back of the gaming machine serves as a display surface.

### RELATED APPLICATION DATA

This application claims priority to U.S. Provisional Application Ser. No. 62/337,682, filed May 17, 2016, the contents of which are incorporated herein entirely by reference.

### BACKGROUND

The disclosed embodiments relate to gaming devices. Gaming machines utilized to present wagering games have been developed in a wide variety of configurations. The most common gaming machine configuration is the “upright” machine. This machine comprises a housing which has a front which faces the player. The housing includes one or more game information display devices. These devices might comprise a set of physical spinning reels or one or more electronic video displays which face the front of the machine towards the player. The back of the gaming machine typically comprises a back of the housing. The back may thus comprise a generally flat, utilitarian panel which is used to enclose the components of the gaming machine.

Gaming machine manufacturers and casino continue to seek to make such gaming machines more interesting and attractive to play. Typically, this is accomplished through lights, backlit printed glass or other features which are located at the front of the gaming machine. One problem with these gaming machines is that they don't include features which are designed to attract potential players who pass behind the gaming machines.

### SUMMARY

The disclosed embodiments have been developed in light of the above and aspects of the invention may include a gaming machine having a secondary projection feature.

In one embodiment, a gaming device or machine has a front and rear. One or more player interface devices are located at the front. The player interface devices may comprise player input devices such as buttons, at least one primary game display device such as reels or a video display, a player tracking device, monetary value accepting device or the like. The player interface devices are configured to be engaged by a player facing the front of the gaming device. At least one secondary display device is configured to display information at the rear of the gaming device.

The at least one secondary display device preferably comprises a projector which is configured to project images or information on a remote surface. Preferably, the projector is configured to project images or information onto the rear of the gaming device. The rear may comprise a back wall of a housing of the gaming device.

The secondary display device may be configured or caused to display various information or images, such as text, photographs, graphics, images or the like. This information may comprise advertising, game information or the like.

In one embodiment, the secondary display device is controlled by a gaming controller of the gaming device which is configured to cause the primary game display device to present game information to the player. In another embodiment, the secondary display device is controlled by a remote computing device, such as a casino system or server.

Advantageously, in accordance with the present invention, the rear of a gaming device may be utilized to make the gaming device more exciting and attractive, to serve as a platform for presenting information to passers-by and the. In one embodiment, the secondary display device may be controlled to present images or information based upon various criteria, such as to display “attract mode” information when the gaming device is not being played, to display game information which relates to a game which is being presented to a player, or based upon other criteria.

Further objects, features, and advantages of the present invention over the prior art will become apparent from the detailed description of the drawings which follows, when considered with the attached figures.

### BRIEF DESCRIPTION OF THE DRAWINGS

FIG. 1 is a front perspective view of a gaming device in accordance with a first embodiment of the invention

FIG. 2 is a rear perspective view of the gaming device illustrated in FIG. 1.

FIG. 3 is a side view of a gaming device in accordance with a second embodiment of the invention.

FIG. 4 is a rear view of the gaming device illustrated in FIG. 3.

FIG. 5 diagrammatically illustrates a configuration of a gaming device and associate gaming system in accordance with an embodiment of the invention.

### DETAILED DESCRIPTION OF EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the disclosed embodiments relate to gaming machines or devices. In one embodiment, the gaming machine includes at least one secondary display device. Preferably, the secondary display device comprises a projection device which is configured to project information. In one embodiment, the at least one projection device is configured to project information onto a rear portion of the gaming machine itself.

A gaming machine of the invention may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

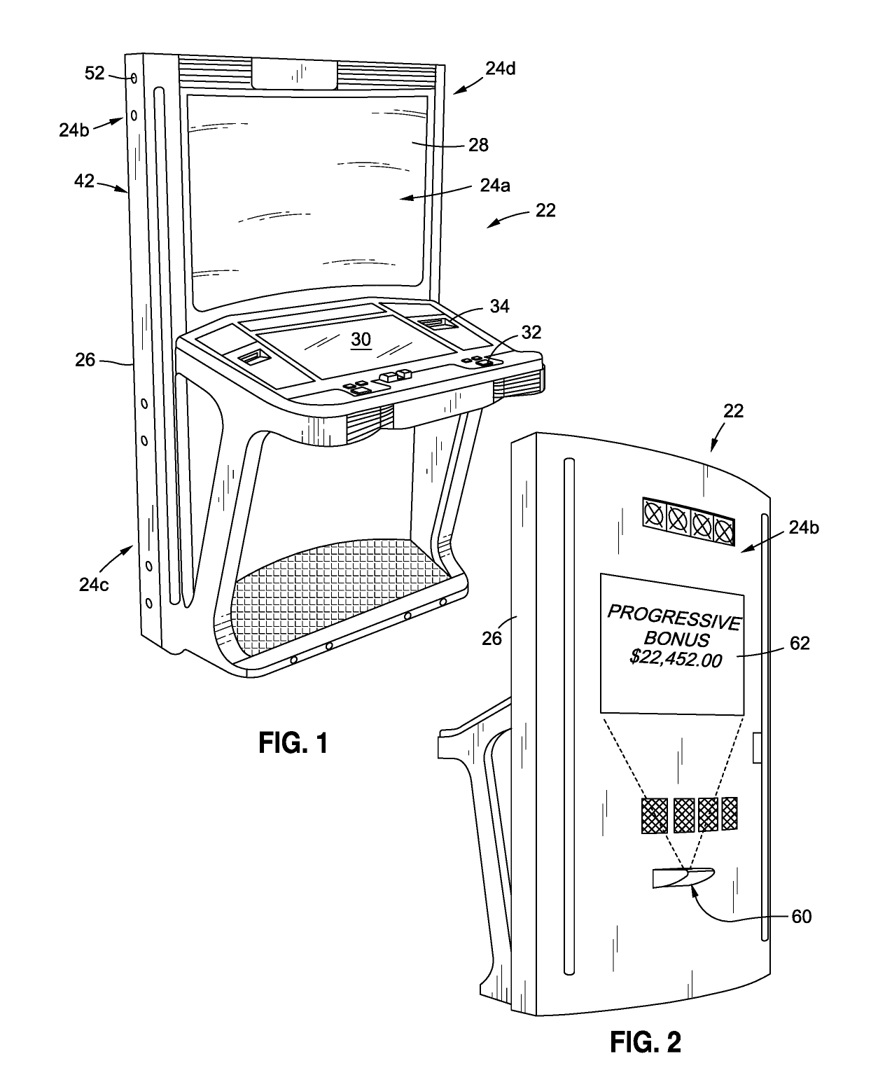

One configuration of a gaming machine or device 22 is illustrated in FIG. 1. As illustrated, the gaming device 22 itself generally comprises a housing or cabinet 26 for supporting and/or enclosing various components required for operation of the gaming device. The configuration of the gaming device 22 may vary. In the embodiment illustrated, the gaming device 22 has an “upright” configuration in which a main display (described below) is generally vertically oriented. However, the gaming device 22 could have other configurations, shapes or dimensions (such as being of a “slant”-type, “bar-top” or other configuration as is well known to those of skill in the art). In one embodiment, the housing 26, and thus the gaming device 22, has a front 24a which is configured to face a player, a generally opposing back 24b, and a pair of opposing sides 24c,d. While the housing 26 may be relatively box-like, the housing 26 may have various shapes and secondary features. For example, as illustrated in FIG. 1, the housing 26 may include an outwardly extending console, various platform or other features (which may be formed as part of the housing or be attached thereto).

In one embodiment, a player interface comprising one or more player interface components are located at the front 24a of the gaming device 22. These components may be mounted to or be associated with the housing 26 in various manners, such as by being located at a front wall of the housing 26, at the console, at the sides 24c,d of the housing or the like, but are preferably configured to be used by a player or players who are facing the front of the gaming device 22 (to provide information or feedback to or receive information or feedback from, a player).

The gaming device 22 preferably includes at least one primary or “game” display 28. The at least one primary display 28 preferably configured to display game information to the one or more players of the gaming device 22. Such information might comprise main game information, bonus or secondary game information or a wide variety of other information, including player tracking information, advertisements and the like. The primary display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display may be capable of projecting or displaying a wide variety of information, including images, symbols and other indicia or information associated with game play, game promotion or other events.

The gaming device 22 might include more than one primary display 28, such as two or more displays 28 which are associated with the housing 26 (such as positioned side-by-side or in a stacked orientation). The gaming device 22 might also include a top box or other portion. Such a top box might include one or more primary displays 28, such as in addition to one or more main displays which are associated with the housing 26. Also, the gaming device 22 might include side displays (such as mounted to the exterior of the housing 26) and might include multiple displays of differing sizes.

While the display devices may comprise one or more video displays, in another embodiment, the gaming device 22 may include one or more physical reels capable of displaying game information, such as slot symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. Of course, other types of display devices might be utilized, such as wheels or the like.

The gaming device 22 is preferably configured to present one or more games upon a player making a monetary payment or wager. In this regard, as described in more detail below, the gaming device 22 includes means for accepting monetary value.

The gaming device 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming device 22. For example, such input devices 30 may be utilized by a player to place a wager, cause the gaming device 22 to initiate a game, to indicate cards to be held or discarded, to “cash out” of the gaming machine, or to provide various other inputs.

In one preferred embodiment, the gaming device 22 includes at least one microprocessor or controller for controlling the gaming machine, including receiving player input and sending output signals for controlling the various components of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28, for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming device 22 may also include one or more random number generators for generating random numbers, such as for use in selecting slot symbols, cards or other game symbols and for presenting the game in a random fashion (e.g. whereby the game is presented in a manner in which the player cannot control the outcome).

Preferably, the controller is configured to execute machine readable code or instructions which are configured to implement the method of game play of the invention. For example, the controller of the gaming device 22 may be configured to detect a wager, such as a signal from a player's depressing of a “bet one” or similar button. Upon such an event and/or the player otherwise signaling the gaming device to present the game, the controller may be configured to cause game symbols or other game information to be displayed on the at least one display 28. The controller may accept input from a player of game inputs, such as a request to spin reels or the like, via the one or more player input devices of the gaming device 22.

The gaming device 22 may be configured to generate and present games in a stand-alone manner or it may be in communication with one or more external devices at one or more times. For example, the gaming device 22 may be configured as a server based device and obtain game code or game outcome information from a remote game server (in which event the gaming device controller may receive game information from the server, such as game outcome information, and use that server-generated information to present the game at the gaming machine).

As indicated, the gaming device 22 is configured to present one or more wagering games. Thus, the gaming device or machines 22 is preferably configured to accept value, such as in the form of coins, tokens, paper currency or other elements or devices representing value such as monetary funds. For example, as illustrated in FIG. 1, the gaming device 22 might include a coin acceptor 32 for accepting coins. Of course, associated coin reading/verifying devices and coin storage devices may be associated with the gaming device 22 if it is configured to accept coins. Likewise, the gaming device 22 might include a media reader 34. Such a reader may be configured to accept and read/verify paper currency and/or other media such as tickets. Of course, in such event the gaming device 22 may further be configured with one or more paper currency or ticket storage devices, such as cash boxes, and other paper currency or media handling devices (including transport devices).

The gaming device 22 might also be configured to read FOBs, magnetic stripe cards or other media having data associated therewith and via which value or funds may be associated with the gaming device 22.

In one embodiment, the gaming device 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming device 22 dispensing coins to a coin tray. In another embodiment, funds may be issued by dispensing paper currency. In yet another embodiment, a player may be issued a media, such as a printed ticket, which ticket represents the value which was paid or cashed out of the machine.

As indicated herein, a casino may have numerous gaming devices of the invention, such as located on a casino floor or in other locations. Of course, such gaming devices might be used in other environments, such as an airport, a bar or tavern or other locations.

It will be appreciated that the gaming device illustrated in FIG. 1 is only exemplary of one embodiment of a gaming machine or device. For example, it is possible to for the gaming device to have various other configurations, including different shapes and styles and having different components other than as just described.

In one embodiment, the gaming device 22 preferably includes at least one secondary display device. In a preferred embodiment, the gaming device 22 includes at least one secondary projection device, e.g. a device which is not configured to be directly viewed, but is instead configured to project information onto a remote surface where the information is then visible on that remote surface. Preferably, the at least one projection device is configured to project information onto a surface of the gaming device 22, and most preferably a rear thereof.

FIG. 2 illustrates an embodiment of the invention where a single projector 60 is located at a rear or back 24b of the gaming device 22 and is configured to project information onto the rear or back 24b of the gaming device 22. The projector 60 may comprise any type of projection device now known or later developed, including LED, LCD, DLP and tubed or CRT types.

In the embodiment which is illustrated, the projector 60 is mounted to or associated with the housing 26 of the gaming device 22 and is configured to display or project upwardly towards a top of the back of the gaming device. However, the projector 60 could be mounted in other orientations and display information in other locations. In one embodiment, the projector 60 is configured to display information onto a display area 62 at the rear or back 24b of the gaming device 22. This display area 62 might comprise a relatively smooth portion of the housing 26. In other embodiments, a projection surface might be associated with the housing 26 or otherwise be located at the rear of the gaming device 22. Such a surface might comprise, for example, a fabric material which is applied to the rear of the housing 26.

The at least one secondary display device is preferably configured to display information for viewing by persons looking at the rear of the gaming device 22. This information might be of any type, including but not limited to: advertising, jackpot information, artwork, or even a duplicate of the game information which is displayed to the player of the gaming device 22.

The gaming device 22 might include more than one secondary display device, such as two or more projectors. The projectors might work in unison to display information in a single area or might be configured to display information in two or more locations on the gaming device.

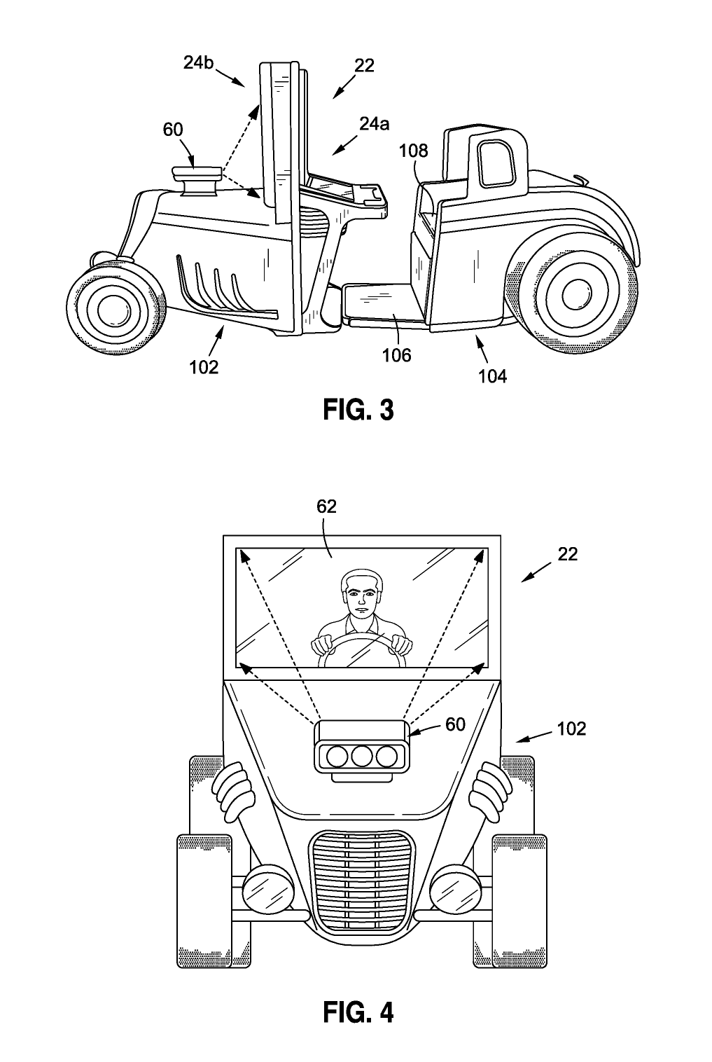

Another embodiment of the invention is illustrated in FIGS. 3 and 4. These figures illustrate another embodiment of a gaming device which has associated thematic elements. Specifically, in this configuration the rear of the gaming device 22 is defined by or includes a first thematic element 102. The first thematic element 102 may be formed as part of the gaming device housing or extends therefrom. In this configuration a front of the gaming device 22 is defined by or includes a second thematic element 104. The second thematic element 104 may be formed as part of the gaming extends from the front 24a of the gaming device 22. The thematic elements 102, 104 may comprise or be defined by a housing, body or combinations of elements constructed to resemble a predetermined theme or motif. In this embodiment, the thematic elements 102, 104 are configured to cause the gaming device to resemble a hot rod. The second thematic element 104 may include a seat 108 and a foot rest 106. In this embodiment, the player may be able to sit in the hot rod on the seat 108 and place his or her foot on the foot rest 106 while facing the front of the gaming device 22 to play games presented thereby.

As illustrated, in this embodiment, a projector 60 is configured to display information onto a surface of the first thematic element 102 which comprises a rear portion of the gaming device 22. In this example, the first thematic element 102 includes an upwardly extending windshield feature which is used as the projection surface. The projector 60 is located in or has a housing which is shaped in the form on engine air intake, thus disguising the projector 60. Once again, the projector 60 is configured to display information at the rear of the gaming device 22. The projector 60 might again be configured to display a wide variety of information. As illustrated in FIG. 4, that information might be the image of a simulated driver of the hot-rod themed gaming device. It is possible for the gaming device to include other projector(s), such as one that projects information onto the back window or trunk of the second thematic element 104 (e.g. projects information onto another surface of the gaming device).

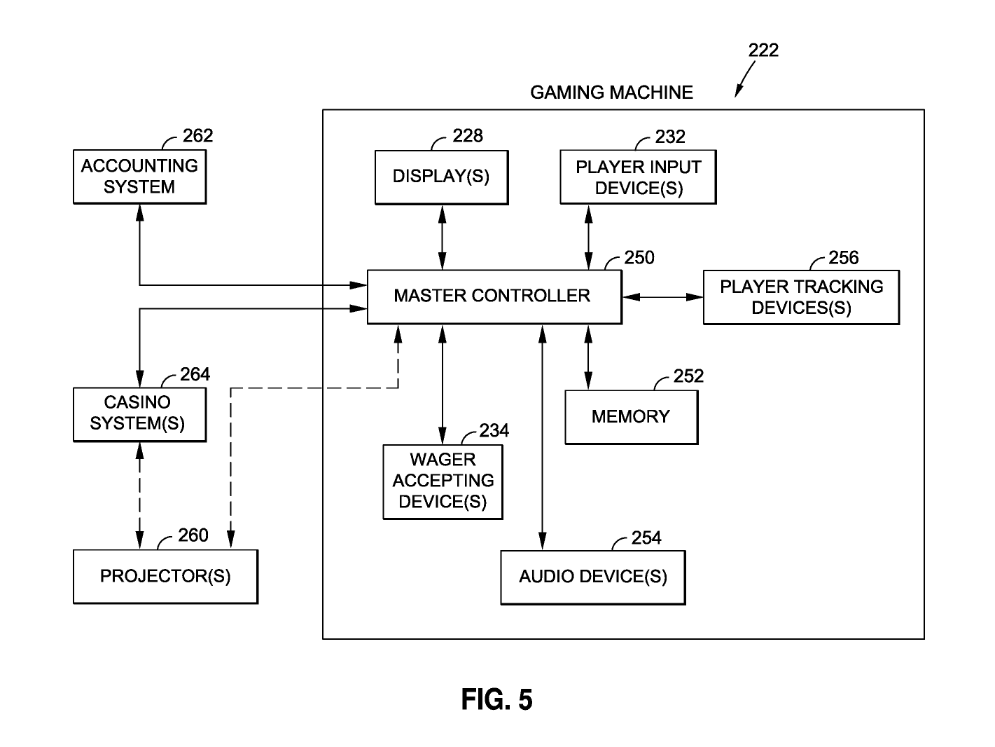

FIG. 5 diagramatically illustrates one embodiment of a gaming device in accordance with the invention. The gaming device 222 includes at least one master gaming controller or processor 250. The master gaming controller 250 is configured to communicate with one or more data storage devices or memory elements 252. The memory 252 may be configured to store data, including machine readable code or “software” which is executable by the master gaming controller 250. The stored data might also comprise, for example, image data which can be used by the projector to display images.

The master gaming controller 250 also communicates with the one or more player input devices 232, wager accepting devices 234, one or more audio devices 254, a player tracking device or interface 256, and other devices or elements, for use in receiving inputs for a player and presenting a game to the player. The gaming device 22 may be communicatively coupled to one or more external devices or systems, such as a casino accounting system/server 262 and other casino systems or servers 264, such as a casino information or player tracking system. These communication links may be wired or wireless and be facilitated by one or more communication interfaces which are associated with the master gaming controller 250, such as in the case of the accounting system, via a “slot accounting system” or “SAS” port of the gaming device 222.

As illustrated, in one embodiment, the master gaming controller 250 may be configured to control the one or more secondary display devices, such as the one or more projectors 260. The master gaming controller 250 might be configured to control or communicate with the projector(s) 260 in various manners. For example, the projector(s) 260 might be configured as USB type devices which communicate with the master gaming controller 250 via a USB interface. In one embodiment, the master gaming controller 250 may be configured, such as by running software, to cause the projector(s) 260 to display certain information at certain times or upon certain criteria or conditions. For example, the master gaming controller 250 might be configured to cause the projector(s) 260 to display advertising or “attract mode” information when the gaming device 22 is not being played (e.g. such as when the gaming device is in idle mode), to display information relating to a player's play of the gaming device when the gaming device 222 is in play (including based upon a game play state), and the like.

In another embodiment, the projector(s) 260 might be controlled by one or more remote computing devices, such as comprising one or more remote devices or systems (or by both the gaming device and such remote devices or systems). For example, as illustrated in FIG. 5, the projector(s) 260 might be controlled via an external casino system 264. Such a system might comprise, for example, a casino advertising or promotion system having one or more computing devices such as servers. This system might control secondary displays or projectors associated with a number of gaming devices. The projectors 260 might be individually addressable, thus allowing the system to cause the projectors 260 to display the same information or different information. For example, such a system might be used to disseminate casino advertising for a new event across a casino floor. As another example, such a system might be used to display jackpot information for linked gaming devices.

The secondary display device of the invention may be configured to display a wide variety of information or images including text, numbers, static images such as photos and graphics, moving images or video or the like.

Of course, it will be appreciated that the secondary display device aspect of the invention might be applied to gaming machines or devices which have different configurations, including shapes, sizes, etc., than are illustrated herein.

The invention has numerous benefits. In accordance with the invention, a simple and cost-effective display mechanism allows secondary content to be displayed at a gaming device. One advantage of the use of a projector is that such a display device is low cost and can easily be mounted to the gaming device (compared, for example, to an electronic video display which generally is mounted through an opening in a housing, which would require the housing of the gaming device to be cut/modified, etc.).

Advantageously, an otherwise unused surface of the gaming device, such as a back of the housing, can be used to display the information. Another advantage of the invention is that information is displayed at the back of the machine, such as to passers-by, thus serving to attract those potential players and without interfering with or disrupting play by a player of the gaming device.

Another advantage of the invention is that the display of information on the back of the gaming device makes the gaming device more aesthetically pleasing. In the past, most gaming devices simply have a black-painted back surface. Using the display or projection feature herein, colorful graphics or video may be displayed, making the gaming device more attractive.

It will thus be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine having a secondary display feature comprising:
a housing having a front and a rear;
one or more player interface devices located at said front of said housing for engagement by a player facing said front, said one or more player interfaces comprising at least one primary game display device; and
at least one secondary display device, said at least one secondary display device configured to display information on a rear of said housing.

2. The gaming machine in accordance with claim 1 wherein said at least one secondary display device comprises at least one projector.

3. The gaming machine in accordance with claim 2 wherein said at least one projector is mounted to said housing at said rear thereof and projects onto said rear of said housing.

4. The gaming machine in accordance with claim 2 wherein said at least one projector comprises at least one of a CRT, LED, LCD or DLP projector which is configured to project one or more images or video onto a remote surface.

5. The gaming machine in accordance with claim 1 wherein said rear of said housing comprises an upwardly extending wall and said at least one secondary display device is configured to display information on said wall.

6. The gaming machine in accordance with claim 1 further comprising a gaming controller configured to cause game information to be displayed by said at least one primary game display device and configured to control said at least one secondary display device.

7. The gaming machine in accordance with claim 1 further comprising a gaming controller configured to cause game information to be displayed by said at least one primary game display device and at least one remote computing device configured to control said at least one secondary display device.

8. The gaming machine in accordance with claim 1 wherein said at least one primary game display device comprises at least one electronic video display and said at least one secondary display device comprises a projector.

9. The gaming machine in accordance with claim 1 wherein said at least one secondary display device comprises a projector which is housed in a housing attached to said housing of said gaming machine.

10. A method of displaying information at a gaming machine comprising:
providing a gaming machine having a front and a rear and one or more player interface devices located at said front for interfacing with a player facing said front of said gaming machine, said at least one player interface comprising at least one primary game display device, a gaming controller configured to cause said at least one primary game display device to display game information to a player, and at least one secondary display device located at said rear of said gaming machine;
causing said at least one secondary display device to project one or more images onto said rear of said gaming machine.

11. The method in accordance with claim 10 wherein said rear of said gaming machine is defined by a rear of a housing of said gaming machine.

12. The method in accordance with claim 10 wherein said one or more images comprises at least one of advertising, secondary game data, a message, a photograph, graphics and video.

13. The method in accordance with claim 10 further comprising transmitting at least one control instruction from said gaming controller to said secondary display device which causes said secondary display device to display said one or more images.

14. The method in accordance with claim 10 wherein said at least one control instruction is transmitted based upon a condition of said gaming machine.

15. The method in accordance with claim 14 wherein said condition comprises an idle condition of said gaming machine.

16. The method in accordance with claim 14 wherein said condition comprises a state of a game being presented by said gaming controller.

17. The method in accordance with claim 10 further comprising transmitting at least one control instruction from a remote computing device to said secondary display device which causes said secondary display device to display said one or more images.
